(19) United States
(12) Patent Application Publication
(10) Pub. No.: US 2026/0323102 A1
(43) Pub. Date: Oct. 15, 2026

(54) TECHNIQUES FOR GENERATING VIDEO STREAMS THAT DESCRIBE CAMERA MOVEMENTS

(71) Applicant: NETFLIX, INC., Los Gatos, CA (US)

(72) Inventors: Zhi LI, Bellevue, WA (US); Joel SOLE ROJALS, San Diego, CA (US); Weiguo ZHENG, San Jose, CA (US)

(21) Appl. No.: 19/364,906

(22) Filed: Oct. 21, 2025

Related U.S. Application Data
(60) Provisional application No. 63/788,704, filed on Apr. 14, 2025.

(51) Int. Cl. H04N 21/235; H04N 21/218; H04N 21/2343; H04N 21/2668

(52) U.S. Cl. CPC H04N 21/2353; H04N 21/21805; H04N 21/23439; H04N 21/2668

(57) ABSTRACT

In various embodiments, custom video feeds are generated for a live event. Multiple enhancement streams are generated based on multiple enhancement video inputs. A video stream is generated based on a live video feed of the live event and transformation metadata that describes one or more camera movements. The video stream and a first enhancement stream are transmitted to a first endpoint device. The first endpoint device generates and plays back a first custom video feed based on the video stream and the first enhancement stream. The video stream and a second enhancement stream are transmitted to a second endpoint device. The second endpoint device generates and plays back a second custom video feed based on the video stream and the second enhancement stream.

### CROSS-REFERENCE TO RELATED APPLICATIONS

This application claims priority benefit of the United States Provisional Patent Application titled, “TECHNIQUES FOR EXTENDING MULTI-LAYER AV1 TO SUPPORT TEXTURE LAYER AFFINE TRANSFORMS,” filed on Apr. 14, 2025 and having Ser. No. 63/788,704. The subject matter of this related application is hereby incorporated herein by reference.

### BACKGROUND

### Field of the Various Embodiments

The various embodiments relate generally to computer science and media streaming technologies and, more specifically, to techniques for generating video streams that describe camera movements.

### Description of the Related Art

In some approaches to streaming live events to televisions and other endpoint devices, a live video feed is encoded in real-time or near real-time to generate a video stream that includes encoded video content. Throughout the live event, the video stream is transmitted to any number of endpoint devices. Each endpoint device decodes the video stream and plays back the resulting reconstructed version of the live video feed, thereby enabling users to view the live event in near real-time.

Oftentimes, the users that stream a live event are located in disparate geographic locations, may speak different languages, and have a wide variety of individual preferences. For these reasons, in some approaches, different advertising inputs, each including advertising content that conforms more to the individual preferences of different viewers, are generated and encoded prior to a given live event to generate different pre-encoded enhancement streams. Throughout the live event, the encoded video stream is transmitted to any number of endpoint devices, and each pre-encoded enhancement stream is transmitted to a different subset of endpoint devices that is associated with the given target audience for that particular enhancement stream. Each endpoint device integrates the enhancement stream received by that endpoint device and the video stream to generate a different custom video stream. The different endpoint devices then decode the custom video streams and play back the resulting custom video feeds, which allows viewers to view the live event in near real-time with integrated advertising that is targeted towards those viewers. For example, where a particular brand of soda is popular in a given geographic location, the custom video feeds generated by the endpoint devices in that given geographic location could include stadium advertising boards featuring the particular brand of soda.

One drawback of the above approach is that, because of pan, rotation, tilt, zoom, and other camera movements that can occur during a live event, the live video feed generated by the different cameras during the live event can become out-of-sync with the advertising inputs that are generated prior to the live event. Once out-of-sync, the ability to re-synchronize reconstructed versions of the live video feed and the advertising inputs is limited, which can substantially reduce the ability to account for camera movements that occur during the live event when generating the custom video feeds and negatively impact overall viewing quality. For example, suppose that a camera generating a live video feed pans to the left during a portion of a live event that is being streamed to users. Reconstructed versions of the video content associated with that portion of the live event that is ultimately included in the custom video feeds would appear to viewers to move from the right to the left. By contrast, reconstructed video content derived from the advertising inputs and included in the custom video feeds would appear stationary to those same viewers. As a result, the degree of realism associated with the custom video feed would be reduced, thereby negatively impacting overall viewing quality.

As the foregoing illustrates, what is needed in the art are more effective techniques for integrating custom content when streaming live events.

### SUMMARY

One embodiment sets forth a computer-implemented method for generating custom video feeds for a live event. The method includes, generating a set of enhancement streams based on a set of enhancement video inputs; generating a video stream based on a live video feed of the live event and transformation metadata that describes one or more camera movements; transmitting the video stream and a first enhancement stream included in the set of enhancement streams to a first endpoint device, where the first endpoint device generates and plays back a first custom video feed based on the video stream and the first enhancement stream; and transmitting the video stream and a second enhancement stream included in the set of enhancement streams to a second endpoint device, where the second endpoint device generates and plays back a second custom video feed based on the video stream and the second enhancement stream.

At least one technical advantage of the disclosed techniques relative to the prior art is that, with the disclosed techniques, endpoint devices can integrate advertising content into custom video feeds in a way that accounts for camera movements that occur when generating a live video feed for a live event. In that regard, the live video feed and transformation metadata that describes the camera movements that occur when generating the live video feed are encoded and transmitted to endpoint devices throughout the live event. Each endpoint device subsequently uses a reconstructed version of the transformation metadata to transform a reconstructed version of advertising content that is targeted for the viewer(s) associated with that endpoint device to account for the different camera movements. Each endpoint device then integrates the transformed advertising content with a reconstructed version of the live video feed to generate and play back a custom video feed that more accurately accounts for camera movements relative to what can be achieved using prior art techniques. As a result, the degrees of realism associated with different custom video feeds can be substantially enhanced, thereby increasing overall viewing quality. These technical advantages provide one or more technical advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a system configured to implement one or more aspects of the various embodiments;

FIG. 2 is a more detailed illustration of the custom decoding application of FIG. 1, according to various embodiments;

FIG. 3 is a flow diagram of method steps for integrating custom content into custom video feeds when streaming a live event, according to various embodiments; and

FIG. 4 is a flow diagram of method steps for transforming custom content to reflect camera movements when streaming a live event, according to various embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details. For explanatory purposes, multiple instances or versions of like objects are denoted with reference numbers identifying the object and parenthetical numbers identifying the instance where needed.

To increase the effectiveness of advertising when streaming a live event, a streaming video provider can enable endpoint devices to generate different custom video feeds. The different custom video feeds allow different viewers to view the live event in real-time or near real-time with different integrated advertising content. Prior to the live event, multiple advertising video inputs, each including advertising content that conforms more to the preferences of a different target audience, are encoded to generate multiple enhancement streams. Throughout the live event, a live video feed is encoded in real-time or near real-time to generate a conventional video stream. Throughout the live event, the conventional video stream is transmitted to any number of endpoint devices, and each enhancement stream is transmitted to a different subset of endpoint devices that is associated with the given target audience for that particular enhancement stream. Each endpoint device integrates the enhancement stream received by that endpoint device and the conventional video stream to generate a different conventional custom video stream. The different endpoint devices then decode the conventional custom video streams and play back the resulting conventional custom video feeds, which allows viewers to view the live event in near real-time with integrated advertising that is targeted towards those viewers.

One drawback of the above approach is that the live video feed reflects pan, rotation, tilt, zoom, and other camera movements that can occur during a live event, while the advertising video inputs are generated prior to the live event and therefore do not reflect the camera movements. As a result, each custom video feed includes some video content that moves with camera(s) capturing the live event and other video content (i.e., custom advertising content) that does not move with the camera(s). As a result, the degrees of realism associated with the custom video feeds can be significantly reduced, thereby negatively impacting overall viewing quality.

With the disclosed techniques, however, a motion estimation application generates transformation metadata that describes camera movements in real-time or near-real time based on the live video feed. Throughout the live event, the live video feed and the transformation metadata are encoded in real-time or near real-time to generate a video stream. Throughout the live event, the video stream is transmitted to any number of endpoint devices, and each enhancement stream is transmitted to a different subset of endpoint devices that is associated with the given target audience for that particular enhancement stream.

To stream the live event to an endpoint device, a custom decoding application executing on the endpoint device integrates the enhancement stream received by that endpoint device with the video stream to generate a custom video stream. The custom decoding application decodes the custom video stream to generate reconstructed versions of the live video feed, advertising content that is targeted to viewer(s) associated with the endpoint device, and the transformation metadata. The custom decoding application computes transformed advertising content that accounts for camera movements that occur when generating the live video feed based on the reconstructed versions of the advertising content and the transformation metadata. The custom decoding application integrates the transformed advertising content with the reconstructed version of the live video feed to generate a custom video feed. A playback application executing on the endpoint device plays back the custom video feed.

At least one technical advantage of the disclosed techniques relative to the prior art is that the transformation metadata enables client devices to integrate different advertising content into custom video feeds for a live event in a way that accounts for camera movements that occur when generating a live video feed for the live event. As a result, the degrees of realism associated with the custom video feeds can be substantially enhanced relative to prior art techniques. And therefore the overall viewing quality when streaming the live event can be increased relative to prior art techniques. These technical advantages provide one or more technical advancements over prior art approaches.

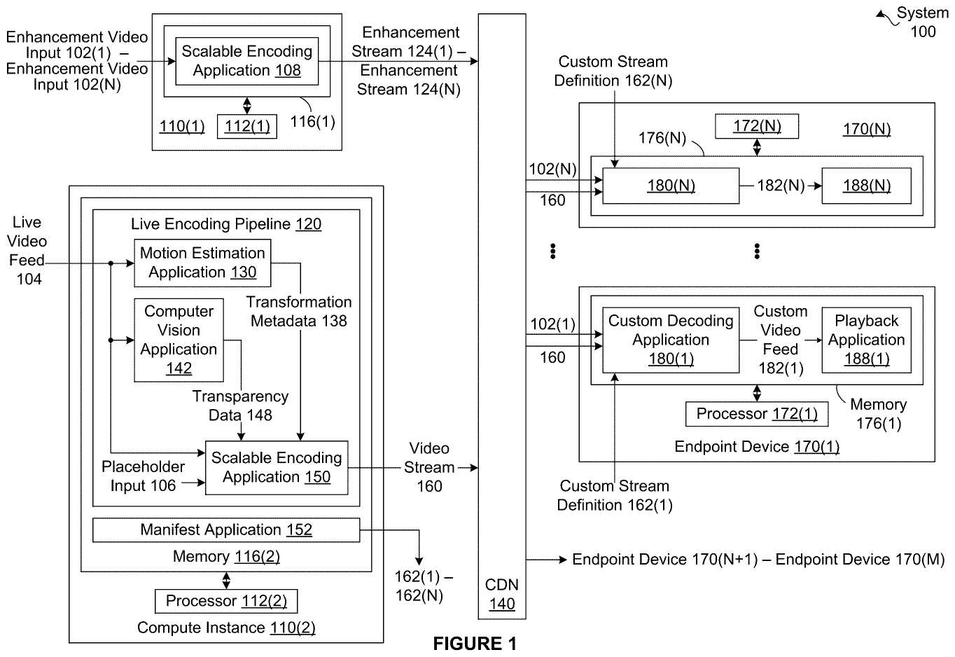

FIG. 1 is a conceptual illustration of a system 100 configured to implement one or more aspects of the various embodiments. As shown, in some embodiments, the system 100 includes, without limitation, a compute instance 110(1), a compute instance 110(2), a content delivery network (CDN) 140, and an endpoint device 170(1)—an endpoint device 170(M), where M is a positive integer. In some embodiments, the system 100 can omit the CDN 140.

For explanatory purposes, the compute instance 110(0) and the compute instance 110(2) are also referred to herein individually as a “compute instance 110” and collectively as “compute instances 110.” The endpoint device 170(1)—the endpoint device 170(M) are also referred to herein individually as an “endpoint device 170” and collectively as “endpoint devices 170.”

Any number of the components of the system 100 can be distributed across multiple geographic locations or implemented in one or more cloud computing environments (e.g., encapsulated shared resources, software, data) in any combination. In some embodiments, the compute instance 110(1), the compute instance 110(2), any number of other compute instances, or any combination thereof can be implemented in a cloud computing environment, implemented as part of any other distributed computing environment, or implemented in a stand—alone fashion.

As shown, in some embodiments, the compute instance 110(1) includes, without limitation, a processor 112(1) and a memory 116(1). The compute instance 110(2) includes, without limitation, a processor 112(2) and a memory 116(2). The processor 112(1) and the processor 112(2) are also referred to herein individually as a “processor 112” and collectively as “processors 112.” The memory 116(1) and the memory 116(2) are also referred to herein individually as a “memory 116” and collectively as “memories 116.”

In some embodiments, each compute instance 110 and each of zero or more other compute instances can include any number of processors 112 and any number of memories 116 in any combination. In the same or other embodiments, the compute instance 110(1), the compute instance 110(2), any number of other compute instances, or any combination thereof can provide any number of multiprocessing environments in any technically feasible fashion.

Each processor 112 can be any instruction execution system, apparatus, or device capable of executing instructions. For example, each processor 112 could comprise a central processing unit, a graphics processing unit, a controller, a microcontroller, a state machine, or any combination thereof. The memory 116 of each compute instance 110 stores content, such as software applications and data, for use by the processor 112 of the compute instance 110.

Each memory 116 can be one or more of any readily available memory, such as random access memory, read-only memory, floppy disk, hard disk, or any other form of digital storage, local or remote. In some embodiments, a storage (not shown) may supplement or replace any number of memories 116. The storage can include any number and/or types of external memories that are accessible to any number of processors 112. For example, and without limitation, the storage can include a Secure Digital Card, an external Flash memory, a portable compact disc read-only memory, an optical storage device, a magnetic storage device, or any suitable combination of the foregoing.

In general, each of the compute instances 110 is configured to implement one or more software applications. For explanatory purposes only, each software application is described as residing in the memory 116 of a single compute instance and executing on the processor 112 of the same compute instance. However, in some embodiments, the functionality of each software application can be distributed across any number of other software applications that reside in the memories of any number of compute instances or other components of the system 100 and execute on the processors of any number of compute instances or other components of the system 100 in any combination. Further, subsets of the functionality of multiple software applications can be consolidated into a single software application.

For explanatory purposes, the functionality of the system 100 is described below in the context of integrating custom content when streaming a live event using a video stream 160 derived from a live video feed 104 of the live event that is delivered to the endpoint devices 170 via the CDN 140. Note, however, that the techniques described herein are illustrative rather than restrictive. Many modifications and variations will be apparent to those of ordinary skill in the art without departing from the scope and spirit of the described embodiments and techniques.

In particular, in some embodiments, the techniques described herein can be modified to integrate custom content when streaming a live event using multiple video streams derived from the live video feed 104, where each video stream is associated with a different combination of bitrate and resolution. In the same or other embodiments, the techniques described herein can be modified and applied to streaming any number of live video feeds of any number of live events to any number and/or types of endpoint devices.

Some examples of live events are a live sporting event, a live television show, a live performance, a live speech, and a live meeting. A live video feed of a live event delivers video content associated with the live event in real-time or near real-time. Each live event can be associated with any number of different live video feeds, where each live video feed is associated with a different source (e.g., recorded by a different camera).

As described previously herein, in one conventional approach to integrating custom advertising when streaming a live event, different advertising inputs, each including advertising content that conforms more to the individual preferences of different viewers, are generated and encoded prior to a given live event to generate different pre-encoded enhancement streams. Throughout the live event, a live video feed is encoded to generate a conventional video stream, the conventional video stream is transmitted to any number of endpoint devices, and each pre-encoded enhancement stream is transmitted to a different subset of the endpoint devices. Each endpoint device integrates the enhancement stream received by that endpoint device and the conventional video stream to generate and play back a different custom video stream.

One drawback of the above conventional approach is that because of camera movements that can occur during a live event, the live video feed generated by the different cameras during the live event can become out-of-sync with the advertising content that is generated prior to the live event. Once out-of-sync, the ability to re-synchronize reconstructed versions of the live video feed and reconstructed versions of the advertising content is limited, which can substantially reduce the ability to account for camera movements that occur during the live event when generating the conventional custom video feeds and negatively impact overall viewing quality.

### Describing Camera Movements via Transformation Metadata

To address the above problems, the compute instance 110(2) is configured to provide transformation metadata 138 that describes camera movements throughout the live event to the endpoint devices 170. More specifically, in some embodiments, the compute instance 110(2) generates the transformation metadata 138 based on the live video feed 104 throughout the live event. The compute instance 110(2) encodes at least the live video feed 104 and the transformation metadata 138 to generate the video stream 160 that is transmitted to the endpoint devices 170 via the CDN 140. Each endpoint device 170 generates a reconstructed version of the live video feed 104 and a reconstructed version of the transformation metadata 138 based on the video stream 160. Each endpoint device 170 uses the reconstructed version of the transformation metadata 138 to transform a reconstructed version of custom content (e.g., advertising content) that is targeted for the viewer(s) associated with the endpoint device 170 to account for the different camera movements. Each endpoint device 170 then integrates the resulting transformed advertising content with the reconstructed version of the live video feed 104 to generate and play back a different custom video feed. Advantageously, with the disclosed techniques, each custom video feed more accurately accounts for camera movements relative to what can be achieved using prior art techniques.

As shown, in some embodiments, the compute instance 110(1) includes, without limitation, a scalable encoding application 108. The scalable encoding application 108 resides in the memory 116(1) of the compute instance 110(1) and executes on the processor 112(1) of the compute instance 110(1). The scalable encoding application 108 implements encoding techniques that are associated with (e.g., based, at least in part, on) a video coding specification for a coder/decoder (codec) and/or a video format that has support for multi-layer streams. Video coding specifications are also commonly referred to as “video codec specifications.” For instance, in some embodiments, the scalable encoding application 108 implements encoding techniques that are associated with an Alliance for Open Media Video 1 (AV1) with Scalable Video Coding (SVC) capabilities or “AV1-SVC” video coding specification.

Prior to the live event, the scalable encoding application 108 generates an enhancement stream 124(1)—an enhancement stream 124(N) based on, respectively, an enhancement video input 102(1)—an enhancement video input 102(N), where N can be any integer that is less than or equal to M. More precisely, the scalable encoding application 108 performs one or more encoding operations on each of the enhancement video input 102(1)—the enhancement video input 102(N) to generate, respectively, the enhancement stream 124(1)—the enhancement stream 124(N).

In some alternate embodiments, any number of instances of the scalable encoding application 108 can generate the enhancement stream 124(1)—the enhancement stream 124(N) based on, respectively, the enhancement video input 102(1)—the enhancement video input 102(N) concurrently, sequentially, or in any combination thereof and over any period of time prior to the live event.

For explanatory purposes, the enhancement video input 102(1)—the enhancement video input 102(N) are also referred to herein individually as an “enhancement video input 102” and collectively as “enhancement video inputs 102.” The enhancement stream 124(1)—the enhancement stream 124(N) are also referred to herein individually as an “enhancement stream 124” and collectively as “enhancement streams 124.”

Each of the enhancement video inputs 102 includes, without limitation, different custom content that can include any amount and/or types of video content. In particular, in some embodiments, each of the enhancement video inputs 102 includes different advertising content that is to be integrated into video content included in the live video feed 104. In some other embodiments, each of the enhancement video inputs 102 can include any amount and/or types of video content that is to be integrated into any number of live video feeds associated with any number of live events. For example, each of the enhancement video inputs 102 could include visual information in a different language that is to be integrated into a scoreboard of a sporting event associated with the live video feed 104.

As persons skilled in the art will recognize, video content includes, without limitation, any number of frames. In some embodiments, each frame of video content includes, without limitation, any number of samples corresponding to a rectangular region of pixels. As used herein, a “sample” is an intersection of a channel and a pixel. A YCbCr color space includes a luma (Y) channel and two chroma channels denoted Cb and Cr. Accordingly, if a frame represents pixels in the YCbCr color space, then the frame includes Y samples, Cb samples, and Cr samples. An RGB color space includes a red (R) channel, a green (G) channel, and a blue (B) channel. Accordingly, if a frame represents pixels in the RGB color space, then the frame includes R samples, G samples, and B samples.

As referred to herein, a “stream” includes, without limitation, at least one encoded version of at least one video source, optionally encoded versions of any amount (including none) and/or types of associated data, and optionally encoded versions of any amount (including none) and/or types of associated metadata (e.g., the transformation metadata 138). Some examples of video sources are the enhancement video inputs 102 and the live video feed 104. Each stream that is derived from a video source includes, without limitation, a sequence of one or more discrete, time-based segments that correspond (in a playback timeline) to a sequence of one or more discrete portions of the video source. For explanatory purposes, a “segment” as used herein refers to a segment of a stream.

Although not shown in FIG. 1, each of enhancement streams 124 includes, without limitation, a different texture enhancement layer. The texture enhancement layers included in the enhancement stream 124(1)—the enhancement stream 124(N) are encoded versions of the custom content included in, respectively, the enhancement video input 102(1)—the enhancement video input 102(N). The enhancement stream 124(1) is described in greater detail below in conjunction with FIG. 1. In some embodiments, each of the enhancement streams 124 can include any number and/or types of other layers. For instance, in some embodiments, each of the enhancement streams 124 includes a placeholder base layer that includes any amount and/or types of encoded background video content (e.g., black frames) that is to be replaced or discarded when generating a custom video stream. As shown, prior to the live event, the scalable encoding application 108 transmits the enhancement streams 124 to the CDN 140.

As shown, in some embodiments, the compute instance 110(2) includes a live encoding pipeline 120 and a manifest application 152. The live encoding pipeline 120 and the manifest application 152 reside in the memory 116(2) of the compute instance 110(2) and execute on the processor 112(2) of the compute instance 110(2). In some alternate embodiments, the functionality of the live encoding pipeline 120 and the manifest application 152 as described herein can be distributed across any number of software applications that reside in the memories of any number of compute instances or other components of the system 100 and execute on the processors of any number of compute instances or other components of the system 100 in any combination.

As shown, the live encoding pipeline 120 generates the video stream 160 based on the live video feed 104. The live video feed 104 includes any amount and/or types of video content associated with the live event that is generated by any number and/or types of cameras during the live event and delivered in real-time or near real-time. The live encoding pipeline 120 includes, without limitation, a motion estimation application 130, a computer vision application 142, and a scalable encoding application 150.

As shown, the motion estimation application 130 generates the transformation metadata 138 based on the live video feed 104. The transformation metadata 138 can describe any number and/or types of movements of one or more cameras or “camera movements” associated with the live video feed 104. For instance, in some embodiments, the transformation metadata 138 describes camera movements that include at least one of a pan, a rotation, a tilt, or a zoom movement performed by a first camera that generates the live video feed 104. Throughout the live event, the motion estimation application 130 performs one or more motion estimation operations on frames included in the live video feed 104 to estimate camera movements across the frames in real-time or near real-time. More specifically, the motion estimation application 130 estimates camera movements associated with each frame of the live video feed 104 based on that frame as well as any number of previous frames of the live video feed 104.

The motion estimation application 130 can describe estimated camera movements via the transformation metadata 138 in any technically feasible fashion that enables the transformation metadata 138 to subsequently be used to modify an enhancement texture layer to account for the estimated camera movements. For instance, in some embodiments, the motion estimation application 130 generates the transformation metadata 138 that specifies any number and/or types of affine transformations, perspective transformations, other geometric transformations, or any combination thereof for each frame of the live video feed 104. The transformation metadata 138 can specify geometric transformations in any technically feasible fashion. For instance, in some embodiments, the transformation metadata 138 includes, without limitation, any amount and/or types of affine motion parameters, perspective motion parameters, other camera movement parameters, other camera motion parameters, or any combination thereof.

As shown, the computer vision application 142 generates transparency data 148 based on the live video feed 104. The transparency data 148 includes, without limitation, any amount and/or types of transparency data associated with each frame of the live video feed 104. In some embodiments, the transparency data 148 includes per-pixel or per-sample transparency data for each frame of the live video feed 104. The transparency data 148 can subsequently be used to blend a reconstructed version of the live video feed 104 with a reconstructed version of custom content that is transformed as per the transformation metadata 138 to generate a custom video feed.

For instance, in some embodiments, the transparency data 148 includes, without limitation, a different frame for each frame of the live video feed 104. Each frame of the transparency data 148 includes, without limitation, one or more samples for each pixel in the corresponding frame of the live video feed 104. Each sample included in the transparency data 148 is an alpha value. An alpha value in the transparency data 148 represents a degree of transparency (or opacity) for use in blending corresponding samples or corresponding pixels of corresponding frames of a reconstructed version of the live video feed 104 and a reconstructed version of custom content that is transformed as per the transformation metadata 138.

The computer vision application 142 can generate the transparency data 148 in real-time or near real-time throughout the live event in any technically feasible fashion. For instance, in some embodiments, the computer vision application 142 performs one or more image segmentation operations and/or any other types of computer vision operations on each frame of the live video feed 104 to generate per-pixel or per-sample transparency data associated with the frame.

More specifically, the computer vision application 142 performs one or more image segmentation operations and/or any other type of computer vision operations on a frame to identify portions of the frame that are to be at least partially occluded by transformed texture enhancement content when generating a custom video feed. For example, the computer vision application 142 could identify portions of the frame that correspond to stadium advertising boards, set per-pixel or per-sample alpha values for the identified portions of the frame to indicate fully transparent, and set the remaining per-pixel or per-sample alpha values to indicate fully opaque.

As shown, throughout the live event, the scalable encoding application 150 incrementally generates the video stream 160 based on the live video feed 104, the transformation metadata 138, the transparency data 148, and a placeholder input 106. As described in greater detail below, the placeholder input 106 includes any background video content (e.g., black frames) that is to be replaced or discarded when generating a custom video stream. Importantly, the video stream 160 is associated with the same video coding specification as the enhancement streams 124.

To ensure that video stream 160 is compatible with the enhancement streams 124, the scalable encoding application 150 implements encoding techniques that are associated with the same video coding specification for the same codec and/or the same video format that has support for multi-layer streams as the scalable encoding application 108. For instance, in some embodiments, both the scalable encoding application 150 and the scalable encoding application 108 implement encoding techniques that are associated with the AV1-SVC video coding specification. In the same or other embodiments, the scalable encoding application 150 and the scalable encoding application 108 are different instances of a single scalable encoding application (not shown) that are configured to generate, respectively, the video stream 160 that includes multiple layers and the enhancement streams 124 that each include a single layer in any technically feasible fashion.

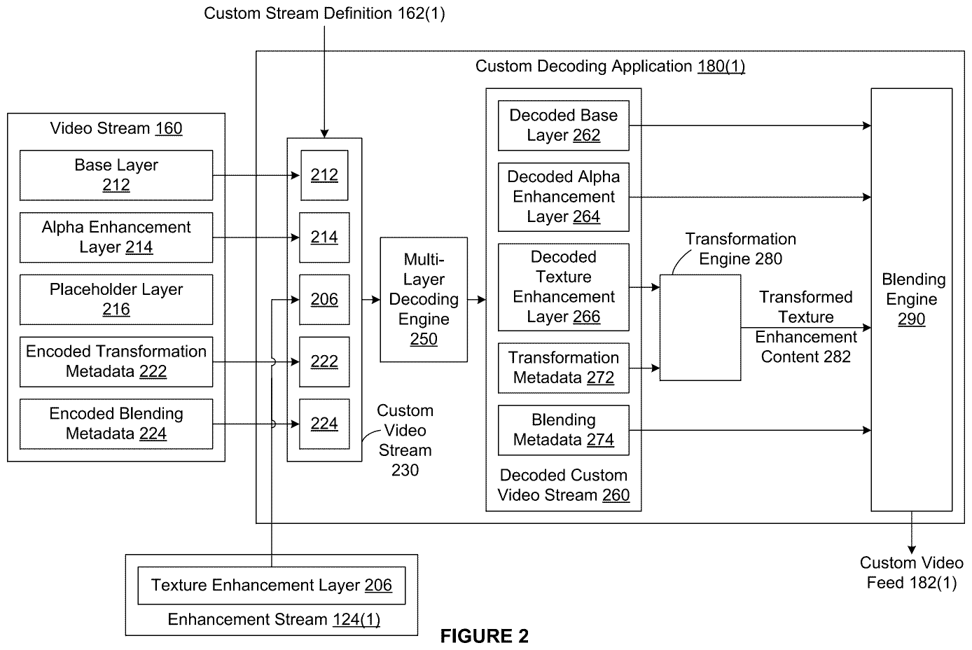

Throughout the live event, the scalable encoding application 150 performs one or more encoding operations on the live video feed 104, the transformation metadata 138, the transparency data 148, and the placeholder input 106 to periodically generate different segments of the video stream 160. As described in greater detail below in conjunction with FIG. 2, the video stream 160 includes, without limitation, a base layer, an alpha enhancement layer, a placeholder layer, encoded transformation metadata, and encoded blending metadata. The base layer is an encoded version of the live video feed 104. The alpha enhancement layer is an encoded version of the transparency data 148. The placeholder layer is an encoded version of the placeholder input 106. The encoded transformation metadata is an encoded version of the transformation metadata 138. The encoded blending metadata is an encoded version of blending metadata (not shown),

As described in greater detail below in conjunction with FIG. 2, the blending metadata indicates a blending process that is to be performed on a decoded version of the base layer and transformed texture enhancement content using a decoded version of the alpha enhancement layer when generating a custom video feed. Some examples of blending processes are, without limitation, a premultiplied alpha blending process in the YCbCr color space, a straight alpha blending process in the YCbCr color space, and a straight alpha blending process in the RGB color space. In a premultiplied alpha blending process, the enhancement video inputs 102 are modified based on the blending metadata prior to encoding. In a straight alpha blending process, the enhancement video inputs 102 are not modified prior to encoding.

Prior to the live event, the manifest application 152 generates a custom stream definition 162(1)—a custom stream definition 162(N). The custom stream definition 162(1)—the custom stream definition 162(N) define different custom video streams derived from the video stream 160 that is to be generated during the live event. The custom stream definition 162(1)—a custom stream definition 162(N) are also referred to herein individually as a “custom stream definition 162” and collectively as “custom stream definitions 162.”

The custom stream definition 162(1)—the custom stream definition 162(N) indicate that associated custom video streams are to include the texture enhancement layer from, respectively, the enhancement stream 124(1)—the enhancement stream 124(N) and the base layer, the alpha enhancement layer, the encoded transformation metadata, and the encoded blending metadata from the video stream 160. In particular, the custom stream definition 162(1) indicates that an associated custom video stream is to include the texture enhancement layer from the enhancement stream 124(1) and the base layer, the alpha enhancement layer, the encoded transformation metadata, and the encoded blending metadata from the video stream 160. And the custom stream definition 162(N) indicates that an associated custom video stream is to include the texture enhancement layer from the enhancement stream 124(N) and the base layer, the alpha enhancement layer, the encoded transformation metadata, and the encoded blending metadata from the video stream 160.

During the live event, as the scalable encoding application 150 generates each segment of the video stream 160, the scalable encoding application 150 transmits the segment of the video stream 160 to the CDN 140. The CDN 140 stores and transmits or “delivers” on-demand segments of the enhancement streams 124 and segments of the video stream 160 to the endpoint devices 170.

Each of the endpoint device 170 can be any type of device that includes at least one processor and one memory and is capable of generating, decoding, and playing back custom video streams as specified in the custom stream definitions 162. Some examples of endpoint devices include, without limitation, desktop computers, laptops, smartphones, smart televisions, game consoles, tablets, and set-top boxes.

As shown, in some embodiments, the endpoint device 170(1) includes, without limitation, a processor 172(1) and a memory 176(1). As also shown, the endpoint device 170(N) includes, without limitation, a processor 112(N) and a memory 116(N). Although not shown, each of the endpoint device 170(2)—the endpoint device 170(N−1) and each of the endpoint device 170(N+1)—the endpoint device 170(M) includes, without limitation, at least one processor and at least one memory.

The processor 172(1), the processor 172(N), and any other processors included in the endpoint devices 170 are also referred to herein individually as a “processor 172” and collectively as “processors 172.” The memory 176(1), the memory 176(N), and any other memories included in the endpoint devices 170 are also referred to herein individually as a “memory 176” and collectively as “memories 176.” Each processor 172 can be any instruction execution system, apparatus, or device capable of executing instructions. The memory 176 of each endpoint device 170 stores content, such as software applications and data, for use by the processor 172 of the endpoint device 170. Each memory 176 can be one or more of any readily available memory, such as random access memory, read-only memory, floppy disk, hard disk, or any other form of digital storage, local or remote. In some embodiments, a storage (not shown) may supplement or replace any number of memories 176. The storage can include any number and/or types of external memories that are accessible to any number of processors 172.

In general, each of the endpoint devices 170 is configured to implement one or more software applications. As shown, in some embodiments, a custom decoding application 180(1) and a playback application 188(1) reside in the memory 176(1) of the endpoint device 170(1) and execute on the processor 172(1) of the endpoint device 170(1). As also shown, a custom decoding application 180(N) and a playback application 188(N) reside in the memory 176(N) of the endpoint device 170(N) and execute on the processor 172(N) of the endpoint device 170(N).

Although not explicitly shown, a custom decoding application 180(2)—a custom decoding application 180(N−1) and a playback application 188(2)—a playback application 188(N−1) reside in the memories of, respectively, the endpoint device 170(2) —the endpoint device 170(N) and execute on the processors of, respectively, the endpoint device 170(2)—the endpoint device 170(N−1). Although not explicitly shown, a custom decoding application 180(N+1)—a custom decoding application 180(M) and a playback application 188(N+1)—a playback application 188(M) reside in the memories of respectively, the endpoint device 170(N+1)—the endpoint device 170(M) and execute on the processors of, respectively, the endpoint device 170(N+1)—the endpoint device 170(M).

Each of the custom decoding application 180(1)—the custom decoding application 180(M) is a different instance of the custom decoding application 180 (not explicitly shown). Each of the playback application 188(1)—the playback application 188(M) is a different instance of a playback application 188 (not explicitly shown).

Prior to or during the live event, to enable the endpoint device 170 to stream the live event, the manifest application 152 selects one of the custom stream definitions 162 based on a target audience associated with the endpoint device and transmits the selected custom stream definition to the endpoint device 170. Throughout the live event, the instance of the custom decoding application 180 that is executing on the endpoint device 170 requests and receives from the CDN 140 segments of the video stream 160 and corresponding segments of the enhancement stream 124 specified in the selected custom stream definition. The custom decoding application 180 generates a custom video stream in accordance with the selected custom stream definition. The custom decoding application 180 decodes the custom video stream to generate a decoded base layer, a decoded alpha enhancement layer, a decoded texture enhancement layer, a reconstructed version of the transformation metadata, and a reconstructed version of the blending metadata. The custom decoding application 180 computes transformed texture enhancement content based on the decoded texture enhancement layer and the reconstructed version of the transformation metadata. The custom decoding application 180 performs one or more blending operations on the decoded base layer and the transformed texture enhancement content using the decoded alpha enhancement layer as per the reconstructed version of the blending metadata to generate a custom video feed. An instance of the playback application 188 that is executing on the endpoint device 170 plays back the custom video feed that includes custom content that properly targets the audience associated with the endpoint device.

For explanatory purposes only, the functionality of the system 100 is described and depicted in greater detail in FIG. 1 in the context of streaming the live event with different integrated advertising to each of the endpoint device 170(1)—the endpoint device 170(N). As shown, in some embodiments, the manifest application 152 transmits the custom stream definition 162(1)—the custom stream definition 162(N) to, respectively, the endpoint device 170(1)—the endpoint device 170(N) prior to the live event. Throughout the live event, the endpoint device 170(1)—the endpoint device 170(N) request from the CDN 140 segments of the video stream 160 and corresponding segments of, respectively, the enhancement stream 124(1)—the enhancement stream 124(N). In response, the CDN 140 transmits requested segments of the video stream 160 to the endpoint devices 170 and requested segments of the enhancement stream 124(1)—the enhancement stream 124(N) to, respectively, the endpoint device 170(1)—the endpoint device 170(N).

In this fashion, the custom decoding application 180(1)—the custom decoding application 180(N) acquire, respectively, the custom stream definition 162(1)—the custom stream definition 162(N), incrementally acquire the video stream 160, and incrementally acquire, respectively, the enhancement stream 124(1)—the enhancement stream 124(N). Throughout the live event, the custom decoding application 180(1)—the custom decoding application 180(N) generate, respectively, a custom video feed 182(1)—a custom video feed 182(N) in accordance with, respectively, the custom stream definition 162(1)—the custom stream definition 162(N). The functionality of the custom decoding application 180 is described in greater detail in the context of the custom decoding application 180(1) below in conjunction with FIG. 2.

As used herein, a “video feed” is associated with a live event, delivers video content associated with the live event in real-time or near real-time, and optionally delivers any amount and/or types of other video content. In particular, each of the custom video feed 182(1)—a custom video feed 182(N) delivers a reconstructed version of the video content included in the live video feed 104 that is modified to include different transformed texture enhancement content. The different transformed texture enhancement content are reconstructed versions of different custom content that are transformed to account for camera movements associated with the live event.

Throughout the live event, the playback application 188(1)—the playback application 188(N) playback, respectively, the custom video feed 182(1)—the custom video feed 182(N). Importantly, each of the custom video feed 182(1)—the custom video feed 182(N) includes different integrated custom content (e.g, different integrated advertising content). And the transformation metadata 138 enables the custom decoding application 180(1)—the custom decoding application 180(N) to account for camera movements associated with the live video feed 104 when integrating different custom advertising to generate, respectively, the custom video feed 182(1)—the custom video feed 182(N). As a result, the degrees of realism associated with the custom video feed 182(1)—the custom video feed 182(N) can be substantially enhanced relative to what can be achieved using prior art techniques, thereby increasing overall viewing quality.

Note that the techniques described herein are illustrative rather than restrictive and can be altered without departing from the broader spirit and scope of the invention. Many modifications and variations on the functionality of the scalable encoding application 108, the live encoding pipeline 120, the motion estimation application 130, the computer vision application 142, the scalable encoding application 150, the manifest application 152, the custom decoding application 180, and the playback application 188 as described herein will be apparent to those of ordinary skill in the art without departing from the scope and spirit of the described embodiments.

For instance, in some embodiments, the live encoding pipeline 120 and/or the scalable encoding application 150 receive the transformation metadata 138 from one or more cameras that generate the live video feed 104, and the motion estimation application 130 is omitted from the system 100. In the same or other embodiments, the scalable encoding application 150 does not add encoded transformation metadata to the video stream 160, and the live encoding pipeline 120 can transmit the transformation metadata 138 to the endpoint devices 170 in any technically feasible fashion during the live event. The functionality of the custom decoding application 180 is modified accordingly.

In some embodiments, the scalable encoding application 150 does not use the placeholder input 106, and the placeholder input 106 can be omitted from the system 100. In the same or other embodiments, the scalable encoding application 150 does not generate encoded blending metadata, and the custom decoding application 180 can implement any type of blending process in any technically feasible fashion.

In some embodiments, any number of video streams can be generated based on any number of live video feeds of any number of live events. Different endpoint devices can acquire and decode different combinations of one of the video streams and one of the enhancement streams 124 to generate different custom video feeds associated with any number of live events. For instance, in some embodiments, the scalable encoding application 150 generates and stores in the CDN 140 a second video stream based on a second live video feed of a second live event. During the second live event, the CDN 140 transmits the second video stream and the enhancement stream 124(1) to the endpoint device 170(M). The custom decoding application 180(M) generates a custom video feed associated with the second live event based on the second video stream and the enhancement stream 124(1). The playback application 188(M) plays back the custom video feed associated with the second live event.

Similarly, many modifications and variations on the storage and delivery of the enhancement streams 124, the video stream 160, and the custom stream definitions 162 as described herein will be apparent to those of ordinary skill in the art without departing from the scope and spirit of the described embodiments. For instance, in some embodiments, the CDN 140 is replaced by any amount and/or types of storage, and the techniques described herein are modified accordingly.

In some embodiments, any types of portions (e.g., segments, layers) of the enhancement streams 124, the video stream 160, or any combination thereof are stored and delivered to any number and/or types of devices in any technically feasible fashion. For instance, in some embodiments, the placeholder layer included in the video stream 160 is not stored in the CDN 140, and the techniques implemented by the custom decoding application 180 are modified accordingly.

It will be appreciated that the system 100 shown herein is illustrative and that variations and modifications are possible. For example, the functionality provided by the scalable encoding application 108, the live encoding pipeline 120, the motion estimation application 130, the computer vision application 142, the scalable encoding application 150, the manifest application 152, the custom decoding application 180, the playback application 188, the compute instances 110, the endpoint devices 170, and the CDN 140 as described herein can be integrated into or distributed across any number of software applications (including one), and any number of components of the system 100. Further, the connection topology between the various units in FIG. 1 can be modified as desired.

### Transforming and Integrating Custom Content When Streaming a Live Event

FIG. 2 is a more detailed illustration of the custom decoding application 180(1) of FIG. 1, according to various embodiments. As described previously herein, the custom decoding application 180(1) is an instance of the custom decoding application 180. As shown, the custom decoding application 180(1) generates the custom video feed 182(1) based on the enhancement stream 124(1) and the video stream 160 in accordance with the custom stream definition 162(1). Notably, the enhancement stream 124(1) and the video stream 160 are both associated with the same video coding specification. For instance, in some embodiments, the video stream 160 and the enhancement stream 124(1) are both associated with the AV 1-SVC video coding specification.

As shown, the enhancement stream 124(1) includes, without limitation, a texture enhancement layer 206. As described previously herein in conjunction with FIG. 1, the enhancement stream 124(1) is generated prior to the live event associated with the video stream 160.

As shown, the video stream 160 is a multi-layer stream that includes, without limitation, a base layer 212, an alpha enhancement layer 214, a placeholder layer 216, encoded transformation metadata 222, and encoded blending metadata 224. The encoded transformation metadata 222 is an encoded version of the transformation metadata 138 described previously herein in conjunction with FIG. 1. The encoded blending metadata 224 is an encoded version of blending metadata that includes any amount and/or types of metadata relevant to multi-layer blending. For instance, in some embodiments, the blending metadata describes a blending process that involves one or more of the layers included in the video stream 160.

As described previously herein in conjunction with FIG. 1, the video stream 160 is incrementally generated throughout the live event based on the live video feed 104 (not shown in FIG. 2) of the live event. More specifically, in some embodiments, the scalable encoding application 150 sequentially encodes portions of the live video feed 104 to generate a sequence of segments included in the video stream 160.

The custom stream definition 162(1) specifies that a custom video stream 230 is to include the texture enhancement layer 206 from the enhancement stream 124(1) and the base layer 212, the alpha enhancement layer 214, the encoded transformation metadata 222, and the encoded blending metadata 224 from the video stream 160.

As shown, the custom decoding application 180(1) includes, without limitation, a multi-layer decoding engine 250, a transformation engine 280, and a blending engine 290. The custom decoding application 180(1) generates a custom video stream 230 based on the video stream 160 and the enhancement stream 124(1) in accordance with the custom stream definition 162(1). Importantly, the custom video stream 230 is associated with the same video coding specification as the enhancement stream 124(1) and the video stream 160. The custom decoding application 180(1) can generate the custom video stream 230 in any technically feasible fashion.

For instance, in some embodiments, the custom decoding application 180(1) aggregates the texture enhancement layer 206 from the enhancement stream 124(1) and the base layer 212, the alpha enhancement layer 214, the encoded transformation metadata 222, and the encoded blending metadata 224 from the video stream 160 to generate the custom video stream 230. In some other embodiments, the custom decoding application 180(1) replaces the placeholder layer 216 included in video stream 160 with the texture enhancement layer 206 included in the enhancement stream 124(1) to generate the custom video stream 230.

As shown, the multi-layer decoding engine 250 performs any number and/or types of decoding operations on the custom video stream 230 to generate a decoded custom video stream 260. Notably, the multi-layer decoding engine 250 implements decoding operations that are associated with the same video coding specification as the custom video stream 230. The decoded custom video stream 260 includes, without limitation, a decoded base layer 262, a decoded alpha enhancement layer 264, a decoded texture enhancement layer 266, transformation metadata 272, and blending metadata 274.

The decoded base layer 262 is a decoded version of the base layer 212 and includes a reconstructed version of the live video feed 104 of FIG. 1. The decoded alpha enhancement layer 264 is a decoded version of the alpha enhancement layer 214 and includes a reconstructed version of the transparency data 148 of FIG. 1. The decoded texture enhancement layer 266 is a decoded version of the texture enhancement layer 206 and includes a reconstructed version of the enhancement video input 102(1) of FIG. 1. The transformation metadata 272 is a decoded version of the encoded transformation metadata 222 and includes a reconstructed version of the transformation metadata 138 of FIG. 1. The blending metadata 274 is a decoded version of the encoded blending metadata 224 and includes a reconstructed version of blending metadata generated by the scalable encoding application 150 as described previously herein in conjunction with FIG. 1.

As shown, the transformation engine 280 computes transformed texture enhancement content 282 based on the decoded texture enhancement layer 266 and the transformation metadata 272. As described previously herein in conjunction with FIG. 1, the enhancement video input 102(1) includes, without limitation, custom content that can include any amount and/or types of video content. And because the decoded texture enhancement layer 266 includes a reconstructed version of the enhancement video input 102(1), the decoded texture enhancement layer 266 includes a reconstructed version of the custom content included in the enhancement video input 102(1). As also described previously herein in conjunction with FIG. 1, the transformation metadata 138 and therefore the transformation metadata 272 describes any number and/or types of movements of one or more cameras associated with the live video feed 104 in any technically feasible fashion.

To compute the transformed texture enhancement content 282, the transformation engine 280 uses the transformation metadata 272 to modify the decoded texture enhancement layer 266 to account for the different camera movements associated with the live video feed 104. More precisely, the transformation engine 280 modifies the reconstructed version of the enhancement video input 102(1) included in the decoded texture enhancement layer 266 based on the transformation metadata 272 to generate the transformed texture enhancement content 282.

Notably, different portions of the transformation metadata 272 can be associated with different frames of the live video feed 104,. Accordingly, the transformation engine 280 modifies each frame included in the decoded texture enhancement layer 266 in accordance with any portion of the transformation metadata 272 that is associated with a corresponding frame included in the live video feed 104. In this fashion, the transformation engine 280 computes the transformed texture enhancement content 282 that accounts for movements associated with one or more cameras during the live event.

As also described previously herein in conjunction with FIG. 1, in some embodiments, the transformation metadata 138 specifies any number and/or types of affine transformations, perspective transformations, other geometric transformations, or any combination thereof for each frame of the live video feed 104. And the transformation engine 280 performs one or more transformations on the reconstructed version of the enhancement video input 102(1) included in the decoded texture enhancement layer 266 based on the transformation metadata 272 to generate the transformed texture enhancement content 282. More specifically, for each frame of (e.g., included in) the decoded texture enhancement layer 266, the transformation engine 280 performs each transformation that is associated with a corresponding frame of the live video feed 104 as per the transformation metadata 272 on that frame of the decoded texture enhancement layer 266 to compute the transformed texture enhancement content 282.

As shown, the blending engine 290 generates the custom video feed 182(1) based on the decoded base layer 262, the decoded alpha enhancement layer 264, the transformed texture enhancement content 282, and the blending metadata 274. More precisely, the blending engine 290 performs one or more blending operations on the decoded base layer 262 and the transformed texture enhancement content 282 using the decoded alpha enhancement layer 264 as per the blending metadata 274 to generate the custom video feed 182(1).

As noted previously herein in conjunction with FIG. 1, in some embodiments, the blending metadata generated by the scalable encoding application 150 and therefore the blending metadata 274 indicates a type of alpha blending process that is to be performed on the decoded base layer 262 and the transformed texture enhancement content 282 using the decoded alpha enhancement layer 264. Together, the decoded alpha enhancement layer 264 and the blending metadata 274 define the relative transparency of each sample of each frame of the transformed texture enhancement content 282 when blended with a corresponding sample of a corresponding frame of the decoded base layer 262.

The blending metadata 274 can indicate any type of alpha blending process in any technically feasible fashion. In some embodiments, the blending metadata 274 indicates a combination of a type of alpha blending process and a color space. The blending engine 290 applies the indicated alpha blending process in the indicated color space to blend each sample of each frame included in the transformed texture enhancement content 282 with a corresponding sample of a corresponding frame included in the decoded base layer 262 using an associated sample of a corresponding frame included in the decoded alpha enhancement layer 264.

For instance, in some embodiments, the blending metadata 274 specifies a premultiplied alpha blending process in the YCbCr color space. The blending engine 290 can implement the following equations (1a)-(1f) to compute samples for a new “display” frame to be added to the custom video feed 182(1) using the premultiplied alpha blending process in the YCbCr color space.
alphaRange=Abs(alphaOpaque−alphaTransparent) (1a)
alphaB=Abs(ay−alphaOpaque) (1b)
dy=ty+(alphaB ×by+alphaRange/2)/alphaRange (1c)
dCb=tCb+(alphaB ×bCb+alphaRange/2)/alphaRange (1d)
dCr=tCr+(alphaB ×bCr+alphaRange/2)/alphaRange (1e)

In equations (1a)-(1e), alphaOpaque denotes an alpha value (e.g., 255) indicating fully opaque; alphaTransparent denotes an alpha value (e.g., 0) indicating fully transparent; dY, dCb, and dCr denote respectively, Y, Cb, and Cr samples for the new display frame; ay denotes a corresponding Y sample from a corresponding frame included in the decoded alpha enhancement layer 264; ty, tCb, and tCr denote, respectively, corresponding Y, Cb, and Cr samples from a corresponding frame included in the transformed texture enhancement content 282; and by, bCb, and bCr denote, respectively, corresponding Y, Cb, and Cr samples from a corresponding frame included in the decoded base layer 262.

In some other embodiments, the blending metadata 274 indicates a straight alpha blending process in the YCbCr color space. The blending engine 290 can implement the following equations (2a)-(2f) to compute samples for a new display frame to be added to the custom video feed 182(1) using the straight alpha blending process in the YCbCr color space.
alphaRange=Abs(alphaOpaque−alphaTransparent) (2a)
alphaT=Abs(ay−alphaTransparent) (2b)
alphaB=Abs(ay−alphaOpaque) (2c)
dy=(alphaT×ty+alphaB×by+alphaRange/2)/alphaRange (2d)
dCb=(alphaT×tCb+alphaB×bCb+alphaRange/2)/alphaRange (2e)
dCr=(alphaT×tCr+alphaB×bCr+alphaRange/2)/alphaRange (2f)

In equations (2a)-(2f), alphaOpaque denotes an alpha value indicating fully opaque; alphaTransparent denotes an alpha value indicating fully transparent; dY, dCb, and dCr denote respectively, Y, Cb, and Cr samples for the new display frame; ay denotes a corresponding Y sample from a corresponding frame included in the decoded alpha enhancement layer 264; ty, tCb, and tCr denote, respectively, corresponding Y, Cb, and Cr samples from a corresponding frame included in the transformed texture enhancement content 282; and by, bCb, and bCr denote, respectively, corresponding Y, Cb, and Cr samples from a corresponding frame included in the decoded base layer 262.

In yet other embodiments, the blending metadata 274 indicates a straight alpha blending process in the RGB color space. The blending engine 290 can implement the following equations (3a)-(3j) to compute samples for a new display frame to be added to the custom video feed 182(1) using the straight alpha blending process in the RGB color space.
alphaRange=Abs(alphaOpaque−alphaTransparent) (3a)
alphaTr=Abs(ar−alphaTransparent) (3b)
alphaBr=Abs(ar−alphaOpaque) (3c)
alphaTg=Abs(ag−alphaTransparent) (3d)
alphaBg=Abs(ag−alphaOpaque) (3e)
alphaTb=Abs(ab−alphaTransparent) (3f)
alphaBb=Abs(ab−alphaOpaque) (3g)
dr=(alphaTr×tr+alphaBr×br+alphaRange/2)/alphaRange (3h)
dg=(alphaTg×tg+alphaBg×bg+alphaRange/2)/alphaRange (3i)
db=(alphaTb×tb+alphaBb×bb+alphaRange/2)/alphaRange (3j)

In equations (3a)-(3j), alphaOpaque denotes an alpha value indicating fully opaque; alphaTransparent denotes an alpha value indicating fully transparent; dr, dg, and db denote respectively, R, G, and B samples for the new display frame; ar, ag, and ab denote respectively, corresponding R, G, and B samples from a corresponding frame included in the decoded alpha enhancement layer 264; tr, tg, and tb denote, respectively, corresponding R, G, and B samples from a corresponding frame included in the transformed texture enhancement content 282; and br, bg, and bb denote, respectively, corresponding R, G, and B samples from the corresponding frame included in the decoded base layer 262.

Importantly, as described previously herein, the custom decoding application 180(1) incrementally generates the custom video feed 182(1) during the live event in real-time or near real-time. The custom decoding application 180(1) can implement any number and/or types of techniques to incrementally generate the custom video feed 182(1).

For instance, in some embodiments, prior to the live event, the custom decoding application 180 acquires the custom stream definition 162(1). After the live event starts, the custom decoding application 180 acquires the encoded blending metadata 224 included in an initial portion of the video stream 160. The multi-layer decoding engine 250 decodes the encoded blending metadata 224 to generate an initial portion of the decoded custom video stream 230 that includes at least the blending metadata 274. During the live event as each new segment of the video stream 160 becomes available, the custom decoding application 180(1) acquires the new segment of the video stream 160 and a corresponding segment of the enhancement stream 124(1). The custom decoding application 180(1) generates a new segment of the custom video stream 230 in accordance with the custom stream definition 162(1) based on the new segment of the video stream 160 and the corresponding segment of the enhancement stream 124(1). The multi-layer decoding engine 250 performs one or more decoding operations on the new segment of the custom video stream 230 to generate a new portion of the decoded custom video stream 260. The new portion of the decoded custom video stream 260 includes at least a new portion of the decoded base layer 262, a new portion of the decoded alpha enhancement layer 264, a new portion of the decoded texture enhancement layer 266, and a new portion of the transformation metadata 272. The transformation engine 280 computes a new portion of the transformed texture enhancement content 282 based on the new portion of the decoded texture enhancement layer 266 and the new portion of the transformation metadata 272. The blending engine 290 performs one or more alpha blending operations on the new portion of the decoded base layer 262 and the new portion of the transformed texture enhancement content 282 using the new portion of the decoded alpha enhancement layer 264 as per the blending metadata 274 to generate a new portion of the custom video feed 182(1).

Note that the techniques described herein are illustrative rather than restrictive and can be altered without departing from the broader spirit and scope of the invention. Many modifications and variations on the functionality of the custom decoding application 180(1), the multi-layer decoding engine 250, the transformation engine 280, and the blending engine 290 as described herein will be apparent to those of ordinary skill in the art without departing from the scope and spirit of the described embodiments.

For instance, in some embodiments, the transformation engine 280 performs one or more intermediate color space conversions before and/or after applying transformation(s) to the decoded texture enhancement layer 266 as per the transformation metadata 272. An example of an intermediate color space conversion is a conversion between a Luma-Chroma color space (e.g., YCbCr) and an RGB color space). In the same or other embodiments, the encoded blending metadata 224 is omitted from the video stream and the blending engine 290 can implement any type of blending process in any technically feasible fashion.

Similarly, many modifications and variations on storage and delivery of the video stream 160, the base layer 212, the alpha enhancement layer 214, the encoded transformation metadata 222, the encoded blending metadata 224, the enhancement stream 124(1), the texture enhancement layer 206, and the custom stream definition 162(1) to the custom decoding application 180(1) as described herein will be apparent to those of ordinary skill in the art without departing from the scope and spirit of the described embodiments.

In some alternate embodiments, the custom stream definition 162(1) specifies that the custom video stream 230 is to include at least the base layer 212 from the video stream 160 and at least the texture enhancement layer 206 from the enhancement stream 124(1). In the same or other embodiments, the enhancement stream 124(1) includes the texture enhancement layer 206 and optionally any number and/or types of other layers (e.g., a base placeholder layer), metadata, encoded metadata (e.g., the encoded blending metadata 224), or any combination thereof. And the video stream 160 includes the base layer 212 and optionally any number and/or types of other layers (e.g., a base placeholder layer), metadata, encoded metadata (e.g., the encoded blending metadata 224), or any combination thereof. The custom decoding application 180(1) can acquire and/or generate the alpha enhancement layer 214, the transformation metadata 272, and optionally the blending metadata 274 in any technically feasible fashion.

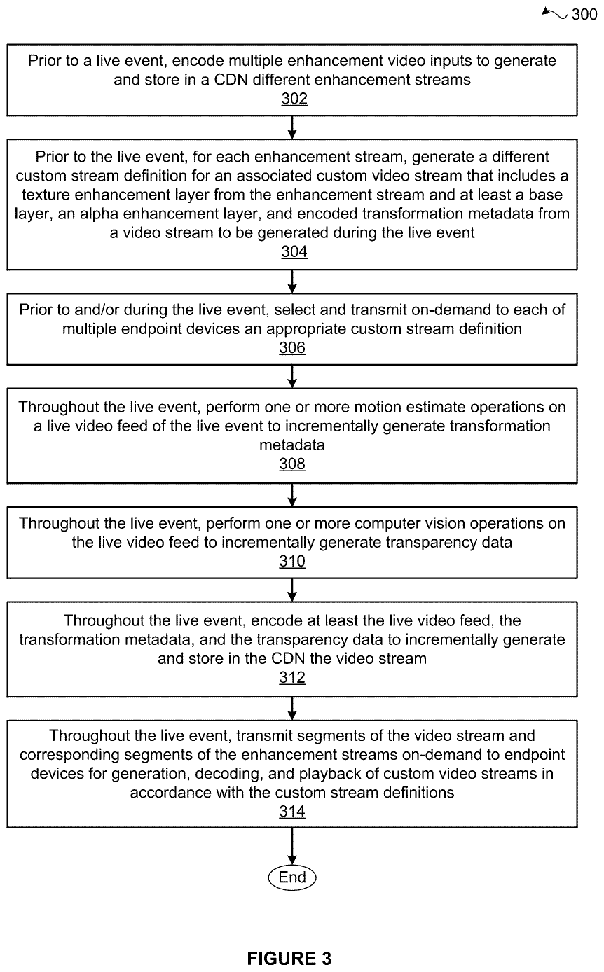

FIG. 3 is a flow diagram of method steps for integrating custom content into custom video feeds when streaming a live event, according to various embodiments. Although the method steps are described with reference to the systems of FIGS. 1 and 2, persons skilled in the art will understand that any system configured to implement the method steps, in any order, falls within the scope of the various embodiments.

As shown, a method 300 begins at step 302, where, prior to a live event, the scalable encoding application 108 encodes multiple enhancement video inputs to generate and store in the CDN 140 different enhancement streams. At step 304, prior to the live event, for each enhancement stream, the manifest application 152 generates a different custom stream definition for an associated custom video stream that includes a texture enhancement layer from the enhancement stream and at least a base layer, an alpha enhancement layer, and encoded transformation metadata from video stream 160 to be generated during the live event. At step 306, prior to and/or during the live event, the manifest application 152 selects and transmits on-demand to each of multiple endpoint devices an appropriate custom stream definition.

At step 308, throughout the live event, the motion estimation application 130 performs one or more motion estimate operations on a live video feed 104 of the live event to incrementally generate transformation metadata 138. At step 310, throughout the live event, the computer vision application 142 performs one or more computer vision operations on the live video feed to incrementally generate transparency data 148.

At step 312, throughout the live event, the scalable encoding application 150 encodes at least the live video feed 104, the transformation metadata 138, and the transparency data 148 to incrementally generate and store in the CDN 140 the video stream 160. At step 314, throughout the live event, the CDN 140 transmits segments of the video stream 160 and corresponding segments of the enhancement streams on-demand to endpoint devices for generation, decoding, and playback of custom video streams in accordance with the custom stream definitions. The method 300 then terminates.

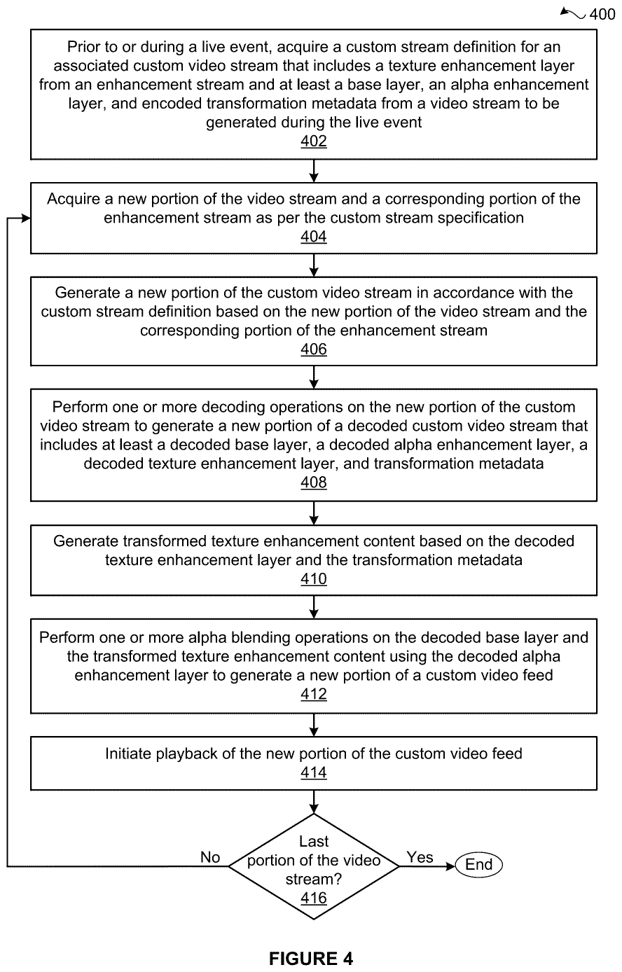

FIG. 4 is a flow diagram of method steps for transforming custom content to reflect camera movements when streaming a live event, according to various embodiments. Although the method steps are described with reference to the systems of FIGS. 1 and 2, persons skilled in the art will understand that any system configured to implement the method steps, in any order, falls within the scope of the various embodiments.

As shown, a method 400 begins at step 402, where, prior to or during a live event, the custom decoding application 180 acquires a custom stream definition for an associated custom video stream that includes a texture enhancement layer from an enhancement stream and at least a base layer, an alpha enhancement layer, and encoded transformation metadata from video stream 160 to be generated during the live event. At step 404, the custom decoding application 180 acquires a new portion of the video stream 160 and a corresponding portion of the enhancement stream as per the custom stream specification.

At step 406, the custom decoding application 180 generates a new portion of the custom video stream in accordance with the custom stream definition based on the new portion of the video stream 160 and the corresponding portion of the enhancement stream. At step 408, the multi-layer decoding engine 250 performs one or more decoding operations on the new portion of the custom video stream to generate a new portion of a decoded custom video stream that includes at least a decoded base layer, a decoded alpha enhancement layer, a decoded texture enhancement layer, and transformation metadata 272.

At step 410, the transformation engine 280 generates transformed texture enhancement content based on the decoded texture enhancement layer and the transformation metadata 272. At step 412, the blending engine 290 performs one or more alpha blending operations on the decoded base layer and the transformed texture enhancement content using the decoded alpha enhancement layer to generate a new portion of a custom video feed. At step 414, the playback application 188 initiates playback of the new portion of the custom video feed.

At step 416, the custom decoding application 180 determines whether the new segment of the video stream 160 is the last segment of the video stream 160. If, at step 416, the custom decoding application 180 determines that the new segment of the video stream 160 is not the last segment of the video stream 160, then the method 400 returns to step 404, where the custom decoding application 180 acquires a new segment of the video stream 160 and a corresponding segment of the enhancement stream.

If, however, at step 416, the custom decoding application 180 determines that the new segment of the video stream 160 is the last segment of the video stream 160, then the method 400 terminates.

In sum, the disclosed techniques can be used to generate different custom video feeds that enable a live event to be played back on various endpoint devices with integrated advertising that is tailored for different target audiences and accounts for camera movements. In some embodiments, prior to the live event, a scalable encoding application generates and stores in a CDN different enhancement streams based on different enhancement video inputs that each include different custom content. For each enhancement stream, a manifest application generates a custom stream definition for a custom video stream that is to include a texture enhancement layer from the enhancement stream and a base layer, an alpha enhancement layer, encoded transformation metadata, and encoded blending metadata from a video stream to be generated during the live event. During the live event, a motion estimation application generates transformation metadata that describes camera movements based on a live video feed of the live event. During the live event, a computer vision application generates transparency data for each frame included in the live video feed of the live event. During the live event, another scalable encoding application incrementally generates and stores in the CDN a video stream based on the live video feed, the transformation metadata, the transparency data, and a placeholder input that is to be replaced with a texture enhancement layer.

To stream the live event to an endpoint device, a custom decoding application executing on the endpoint device acquires one of the custom stream definitions. During the live event, the custom decoding application incrementally retrieves from the CDN the video stream and the enhancement stream specified in the custom stream definition. The custom decoding application incrementally generates a custom video stream in accordance with the custom stream definition. The custom decoding application incrementally performs decoding operations on the custom video stream to incrementally generate a decoded custom video stream that includes a decoded base layer, a decoded alpha enhancement layer, a decoded texture enhancement layer, a reconstructed version of the transformation metadata, and blending metadata. The custom decoding application incrementally modifies the decoded texture enhancement layer based on the reconstructed version of the transformation metadata to generate transformed texture enhancement content. The custom decoding application incrementally performs one or more alpha blending operations on the decoded base layer and the transformed texture enhancement content using the decoded alpha enhancement layer as per the blending metadata to incrementally generate a custom video feed. A playback application executing on the compliant endpoint device incrementally plays back the custom video feed.

At least one technical advantage of the disclosed techniques relative to the prior art is that, with the disclosed techniques, endpoint devices can integrate advertising content into custom video feeds in a way that accounts for camera movements that occur when generating a live video feed for a live event. In that regard, the live video feed and transformation metadata that describes the camera movements that occur when generating the live video feed are encoded and transmitted to endpoint devices throughout the live event. Each endpoint device subsequently uses a reconstructed version of the transformation metadata to transform a reconstructed version of advertising content that is targeted for the viewer(s) associated with that endpoint device to account for the different camera movements. Each endpoint device then integrates the transformed advertising content with a reconstructed version of the live video feed to generate and play back a custom video feed that more accurately accounts for camera movements relative to what can be achieved using prior art techniques. As a result, the degrees of realism associated with different custom video feeds can be substantially enhanced, thereby increasing overall viewing quality. These technical advantages provide one or more technical advancements over prior art approaches.
1. In some embodiments, a computer-implemented method for generating custom video feeds for a live event comprises generating a plurality of enhancement streams based on a plurality of enhancement video inputs; generating a video stream based on a live video feed of the live event and transformation metadata that describes one or more camera movements; transmitting the video stream and a first enhancement stream included in the plurality of enhancement streams to a first endpoint device, wherein the first endpoint device generates and plays back a first custom video feed based on the video stream and the first enhancement stream; and transmitting the video stream and a second enhancement stream included in the plurality of enhancement streams to a second endpoint device, wherein the second endpoint device generates and plays back a second custom video feed based on the video stream and the second enhancement stream.
2. The computer-implemented method of clause 1, wherein the live video feed is generated by a first camera, and the one or more camera movements comprise at least one of a pan, a rotation, a tilt, or a zoom movement performed by the first camera.
3. The computer-implemented method of clauses 1 or 2, further comprising performing one or more motion estimation operations on a plurality of frames included in the live video feed to generate the transformation metadata.
4. The computer-implemented method of any of clauses 1-3, wherein the transformation metadata specifies at least one of an affine transformation or a perspective transformation.
5. The computer-implemented method of any of clauses 1-4, wherein generating the video stream comprises performing one or more image segmentation operations on a frame included in the live video feed to generate transparency data associated with the frame.
6. The computer-implemented method of any of clauses 1-5, wherein each enhancement stream included in the plurality of enhancement streams includes a different texture enhancement layer.
7. The computer-implemented method of any of clauses 1-6, wherein the first endpoint device modifies a reconstructed version of a first enhancement video input based on a reconstructed version of the transformation metadata to generate the first custom video feed.
8. The computer-implemented method of any of clauses 1-7, wherein each enhancement video input included in the plurality of enhancement video inputs includes different advertising content.
9. The computer-implemented method of any of clauses 1-8, further comprising transmitting a first custom stream definition to the first endpoint device specifying that a first custom video stream is to include a texture enhancement layer from the first enhancement stream and at least a base layer from the video stream, wherein the first endpoint device generates the first custom video stream for decoding and playback in accordance with the first custom stream definition.
10. The computer-implemented method of any of clauses 1-9, wherein the transformation metadata specifies at least one transformation that is to be performed on a reconstructed version of a first enhancement video input to account for the one or more camera movements.
11. In some embodiments, one or more non-transitory computer readable media include instructions that, when executed by one or more processors, cause the one or more processors to generate custom video feeds for a live event by performing the steps of generating a plurality of enhancement streams based on a plurality of enhancement video inputs; generating a video stream based on a live video feed of the live event and transformation metadata that describes one or more camera movements; transmitting the video stream and a first enhancement stream included in the plurality of enhancement streams to a first endpoint device, wherein the first endpoint device generates and plays back a first custom video feed based on the video stream and the first enhancement stream; and transmitting the video stream and a second enhancement stream included in the plurality of enhancement streams to a second endpoint device, wherein the second endpoint device generates and plays back a second custom video feed based on the video stream and the second enhancement stream.
12. The one or more non-transitory computer readable media of clause 11, wherein the live video feed is generated by a first camera, and the one or more camera movements comprise at least one of a pan, a rotation, a tilt, or a zoom movement performed by the first camera.
13. The one or more non-transitory computer readable media of clause 11 or 12, further comprising performing one or more motion estimation operations on a plurality of frames included in the live video feed to generate the transformation metadata.
14. The one or more non-transitory computer readable media of any of clauses 11-13, wherein the transformation metadata specifies at least one of an affine transformation or a perspective transformation.
15. The one or more non-transitory computer readable media of any of clauses 11-14, wherein generating the video stream comprises performing one or more image segmentation operations on a frame included in the live video feed to generate per-pixel or per-sample transparency data associated with the frame.
16. The one or more non-transitory computer readable media of any of clauses 11-15, wherein generating the video stream comprises performing one or more encoding operations on the live video feed, the transformation metadata, and transparency data.
17. The one or more non-transitory computer readable media of any of clauses 11-16, wherein the first endpoint device performs one or more transformations on a reconstructed version a first enhancement video input based on a reconstructed version of the transformation metadata to generate the first custom video feed.
18. The one or more non-transitory computer readable media of any of clauses 11-17, wherein each enhancement video input included in the plurality of enhancement video inputs includes different advertising content.
19. The one or more non-transitory computer readable media of any of clauses 11-18, further comprising transmitting a first custom stream definition to the first endpoint device specifying that a first custom video stream is to include a texture enhancement layer from the first enhancement stream and at least a base layer from the video stream, wherein the first endpoint device generates the first custom video stream for decoding and playback in accordance with the first custom stream definition.
20. In some embodiments, a system comprises one or more memories storing instructions and one or more processors coupled to the one or more memories that, when executing the instructions, perform the steps of generating a plurality of enhancement streams based on a plurality of enhancement video inputs; generating a video stream based on a live video feed of a live event and transformation metadata that describes one or more camera movements; transmitting the video stream and a first enhancement stream included in the plurality of enhancement streams to a first endpoint device, wherein the first endpoint device generates and plays back a first custom video feed based on the video stream and the first enhancement stream; and transmitting the video stream and a second enhancement stream included in the plurality of enhancement streams to a second endpoint device, wherein the second endpoint device generates and plays back a second custom video feed based on the video stream and the second enhancement stream.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for generating custom video feeds for a live event, the method comprising:
generating a plurality of enhancement streams based on a plurality of enhancement video inputs;
generating a video stream based on a live video feed of the live event and transformation metadata that describes one or more camera movements;
transmitting the video stream and a first enhancement stream included in the plurality of enhancement streams to a first endpoint device, wherein the first endpoint device generates and plays back a first custom video feed based on the video stream and the first enhancement stream; and
transmitting the video stream and a second enhancement stream included in the plurality of enhancement streams to a second endpoint device, wherein the second endpoint device generates and plays back a second custom video feed based on the video stream and the second enhancement stream.

2. The computer-implemented method of claim 1, wherein the live video feed is generated by a first camera, and the one or more camera movements comprise at least one of a pan, a rotation, a tilt, or a zoom movement performed by the first camera.

3. The computer-implemented method of claim 1, further comprising performing one or more motion estimation operations on a plurality of frames included in the live video feed to generate the transformation metadata.

4. The computer-implemented method of claim 1, wherein the transformation metadata specifies at least one of an affine transformation or a perspective transformation.

5. The computer-implemented method of claim 1, wherein generating the video stream comprises performing one or more image segmentation operations on a frame included in the live video feed to generate transparency data associated with the frame.

6. The computer-implemented method of claim 1, wherein each enhancement stream included in the plurality of enhancement streams includes a different texture enhancement layer.

7. The computer-implemented method of claim 1, wherein the first endpoint device modifies a reconstructed version of a first enhancement video input based on a reconstructed version of the transformation metadata to generate the first custom video feed.

8. The computer-implemented method of claim 1, wherein each enhancement video input included in the plurality of enhancement video inputs includes different advertising content.

9. The computer-implemented method of claim 1, further comprising transmitting a first custom stream definition to the first endpoint device specifying that a first custom video stream is to include a texture enhancement layer from the first enhancement stream and at least a base layer from the video stream, wherein the first endpoint device generates the first custom video stream for decoding and playback in accordance with the first custom stream definition.

10. The computer-implemented method of claim 1, wherein the transformation metadata specifies at least one transformation that is to be performed on a reconstructed version of a first enhancement video input to account for the one or more camera movements.

11. One or more non-transitory computer readable media including instructions that, when executed by one or more processors, cause the one or more processors to generate custom video feeds for a live event by performing the steps of:
generating a plurality of enhancement streams based on a plurality of enhancement video inputs;
generating a video stream based on a live video feed of the live event and transformation metadata that describes one or more camera movements;
transmitting the video stream and a first enhancement stream included in the plurality of enhancement streams to a first endpoint device, wherein the first endpoint device generates and plays back a first custom video feed based on the video stream and the first enhancement stream; and
transmitting the video stream and a second enhancement stream included in the plurality of enhancement streams to a second endpoint device, wherein the second endpoint device generates and plays back a second custom video feed based on the video stream and the second enhancement stream.

12. The one or more non-transitory computer readable media of claim 11, wherein the live video feed is generated by a first camera, and the one or more camera movements comprise at least one of a pan, a rotation, a tilt, or a zoom movement performed by the first camera.

13. The one or more non-transitory computer readable media of claim 11, further comprising performing one or more motion estimation operations on a plurality of frames included in the live video feed to generate the transformation metadata.

14. The one or more non-transitory computer readable media of claim 11, wherein the transformation metadata specifies at least one of an affine transformation or a perspective transformation.

15. The one or more non-transitory computer readable media of claim 11, wherein generating the video stream comprises performing one or more image segmentation operations on a frame included in the live video feed to generate per-pixel or per-sample transparency data associated with the frame.

16. The one or more non-transitory computer readable media of claim 11, wherein generating the video stream comprises performing one or more encoding operations on the live video feed, the transformation metadata, and transparency data.

17. The one or more non-transitory computer readable media of claim 11, wherein the first endpoint device performs one or more transformations on a reconstructed version a first enhancement video input based on a reconstructed version of the transformation metadata to generate the first custom video feed.

18. The one or more non-transitory computer readable media of claim 11, wherein each enhancement video input included in the plurality of enhancement video inputs includes different advertising content.

19. The one or more non-transitory computer readable media of claim 11, further comprising transmitting a first custom stream definition to the first endpoint device specifying that a first custom video stream is to include a texture enhancement layer from the first enhancement stream and at least a base layer from the video stream, wherein the first endpoint device generates the first custom video stream for decoding and playback in accordance with the first custom stream definition.

20. A system comprising:
one or more memories storing instructions; and
one or more processors coupled to the one or more memories that, when executing the instructions, perform the steps of:
generating a plurality of enhancement streams based on a plurality of enhancement video inputs;
generating a video stream based on a live video feed of a live event and transformation metadata that describes one or more camera movements;
transmitting the video stream and a first enhancement stream included in the plurality of enhancement streams to a first endpoint device, wherein the first endpoint device generates and plays back a first custom video feed based on the video stream and the first enhancement stream; and
transmitting the video stream and a second enhancement stream included in the plurality of enhancement streams to a second endpoint device, wherein the second endpoint device generates and plays back a second custom video feed based on the video stream and the second enhancement stream.
